(19) United States
(12) Patent Application Publication
(10) Pub. No.: US 2014/0067842 A1
(43) Pub. Date: Mar. 6, 2014

(54) INFORMATION PROCESSING METHOD AND APPARATUS

(71) Applicant: International Business Machines Corporation, Armonk, NY (US)

(72) Inventors: Jian Chen, Beijing (CN); Yan Li, Beijing (CN); Qiming Teng, Beijing (CN); Haofeng Zhou, Shanghai (CN)

(73) Assignee: International Business Machines Corporation, Armonk, NY (US)

(21) Appl. No.: 14/014,439

(22) Filed: Aug. 30, 2013

(30) Foreign Application Priority Data
Aug. 30, 2012 (CN) 201210316681.3

(51) Int. Cl. G06F 17/30

(52) U.S. Cl. CPC G06F 17/30386
USPC 707/758

(57) ABSTRACT

The invention belongs to the field of text information processing, and discloses an information processing method including: acquiring a first text-based chat record; extracting at least two of topics contained in the first chat record; acquiring a second text-based chat record, the second chat record being associated with at least one of the extracted topics; displaying that the first chat record and the second chat record are in an association relationship. The invention also discloses an information processing apparatus. With the information processing method and apparatus disclosed by the invention, text exchange organized by topics can be realized, and efficiency of text-based communication can be improved.

### CROSS-REFERENCE

This application claims priority under 35 U.S.C. §119 from China Patent Application No. 201210316681.3 filed on Aug. 30, 2012 the entire contents of which are incorporated herein by reference.

### TECHNICAL FIELD

The invention relates to the field of text information processing, and more specifically, to an information processing method and apparatus.

### BACKGROUND

With the continual development of network technology, more and more people are accustomed to conduct information exchange by using texts. For example, text-based information exchange tools such as instant messaging tool, online meeting tool, forum, electronic bulletin board system (BBS) etc have been well-known to people and are widely used in daily life.

However, when there are a relatively large number of items being discussed, especially when there are a lot of people participating in discussion, confusion often occurs. It is hard to tell to which problem mentioned before a speech made by a speaker is directed. This not only may result in misunderstanding among people participating in discussion, but also make it difficult for a collator to sort out the complete tracks when conducting sorting on the discussion afterwards. This reduces efficiency of text-based information exchange, and meanwhile, wastes time and energy of the participants.

### SUMMARY

In order to improve the efficiency of text-based communication, embodiments of the invention provide an information processing method, an apparatus, and a corresponding client.

According to an aspect of the invention, there is provided an information processing method, including: acquiring a first text-based chat record; extracting at least two topics contained in the first chat record; acquiring a second text-based chat record, the second chat record being associated with at least one of the extracted topics; displaying that the first chat record and the second chat record are in an association relationship.

According to another aspect of the invention, there is provided an information processing apparatus, including: a first acquiring module configured to acquire a first text-based chat record; an extraction module configured to extract at least two of topics contained in the first chat record; a second acquiring module configured to acquire a second text-based chat record, the second chat record being associated with at least one of the extracted topics; a first display module configured to display that the first chat record and the second chat record are in an association relationship.

The technical solution provided by the invention can improve efficiency of text-based communication.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 which is applicable to implement an embodiment of the invention;

FIG. 2 shows a flow chart of an information processing method provided in an embodiment of the invention;

FIG. 3 shows an implementation for displaying historical chat records in the art;

FIG. 4a shows one way of providing options in an embodiment of the invention;

FIG. 4b shows another way of providing options in an embodiment of the invention;

FIG. 5a shows an example of displaying that the first chat record and the second chat record are in an association state in an embodiment of the invention;

FIG. 5b shows another example of displaying that the first chat record and the second chat record are in an association state in an embodiment of the invention;

FIG. 5c shows still another example of displaying that the first chat record and the second chat record are in an association state in an embodiment of the invention;

FIG. 6 shows a structure diagram of an information processing apparatus in an embodiment of the invention;

FIG. 7 shows a structure diagram of a client in an embodiment of the invention;

FIG. 8 shows a structure diagram of another client in an embodiment of the invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware components that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the above. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 1 shows a block diagram of an exemplary computer system/server 12 which is applicable to implement embodiments of the invention. The computer system/server 12 as shown in FIG. 1 is merely an example, and it should not limit functions and usage scope of embodiments of the present invention in any way.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not as a limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

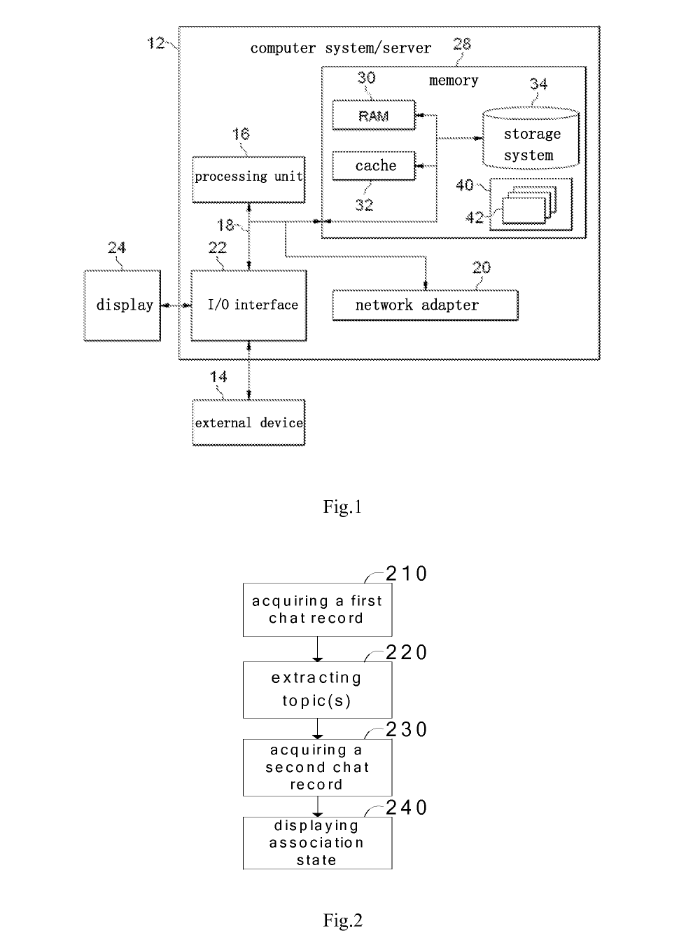

Now referring to FIG. 2, which shows an information processing method provided in an embodiment of the invention. The method includes: step 210, acquiring the first text-based chat record; step 220, extracting at least two of topics contained in the first chat record; step 230, acquiring a second text-based chat record, the second chat record being associated with at least one of the extracted topics; step 240, displaying that the first chat record and the second chat record are in an association relationship.

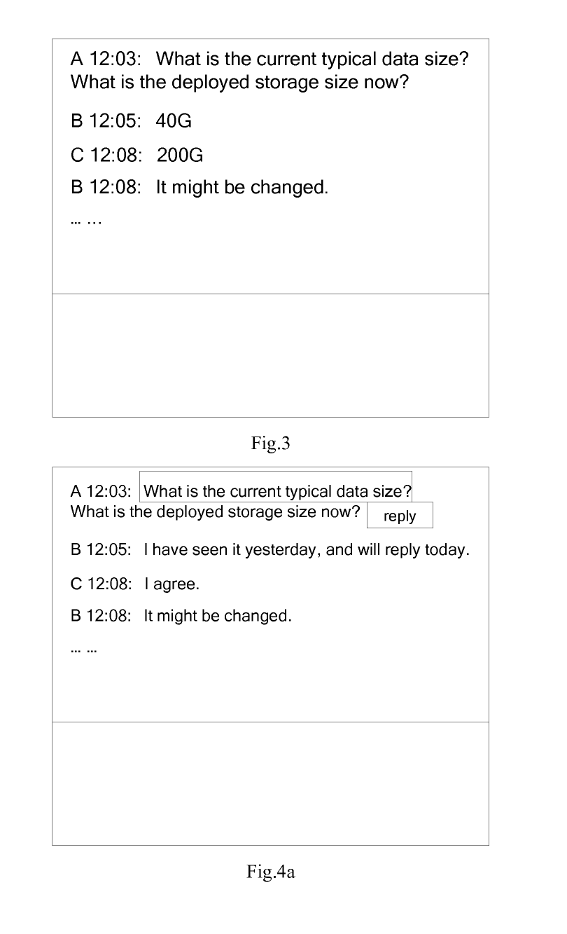

In this embodiment, it is achieved that, topics are extracted for chat record containing a plurality of topics, thereby associating other chat records with the extracted topics, thus, chat records with related topics may be associated and displayed together, so as to help participants understand the relationship and logic flow among chat records and also facilitate sorting the chat records afterwards. As shown in FIG. 3, chat record of speaker A on 12:03 contains two topics, one is to ask typical data size, the other is to ask storage size. With prior technology, for 40G answered by speaker B and 200G answered by speaker C, it will easily confuse both participants and the people responsible for collation which answer corresponds to which problem. While with the method provided by the embodiment of the invention, two topics in chat record of speaker A on 12:03 may be acquired, and by acquiring chat records associated with these two topics respectively and presenting the association relationship to participants or collator, the participants or collator can clearly understand association relationships among different chat records, so that communication or collation can be conducted more efficiently. It can be seen that, the method provided by the embodiment of the invention is capable of presenting association among different chat records according to logic association among topics, thereby promoting communication efficiency of text-based information exchange.

Those skilled in the art can appreciate that, a topic may be a paragraph or a sentence, or may even be central idea expressed by a portion of a sentence. Topics may be divided or induced at different abstraction level, i.e. either at clause level or dialog level. Alternatively, topics in embodiments of the invention may be at dialog level. In embodiments of the invention, original text may be taken as topic, or central idea abstracted from original text may be taken topic, the invention has no limitation thereon.

In embodiments of the invention, a text-based chat record may include at least one of: a chat record inputted in text form; a chat record inputted in voice form and transformed into text via speech recognition technology; a chat record outputted in text form.

In an embodiment of the invention, step 220 may include: detecting keyword(s) contained in the first chat record, the keyword(s) including at least one of keyword for representing a transition, keyword for representing asking a question and keyword for representing sequence; dividing the first chat record into a plurality of topics according to the detected keyword(s), at least two of the plurality of topics resulted from the division are used as at least two of topics contained in the first chat record. The embodiment provides a relatively simple method to divide the first chat record into a plurality of topics, thereby realizing automatic extraction of topics. The method is mainly based on keyword detection, a sentence or a portion thereof containing a keyword is taken as a topic, or keyword is used as a division criterion to derive a plurality of topics, wherein keyword for representing a transition may include, for example: however, but, another thought, another thing, further, by the way, etc. Generally, such keyword representing a transition will lead to another topic, wherein keyword for representing asking a question may include, for example: what, how, when, who, how long, how many, why etc or a symbol representing question, such as a question mark, wherein keyword for representing sequence may include, for example: first, second, firstly, secondly etc. It can be seen that, keyword is not limited to word, phrase, it may also be a symbol. For example, a piece of chat record of user A is “It is a nice day today. Where are you? Do you want to go to amusement park tomorrow? By the way, I will probably move.” According to the method provided by the embodiment, it can be divided as follows: content before the question is grouped into one topic, two questions are grouped into two topics, and the portion beginning with “By the way” is grouped into one topic. Thus, four topics “It is a nice day today”, “Where are you”, “Do you want to go to amusement park tomorrow”, and “By the way, I will probably move” can be acquired in that chat record. It can be seen that, the method provided by the embodiment can realize automatic topic recognition in a very simple and effective way. Those skilled in the art can appreciate that, the acquired topics may be all of the original text or a portion thereof, or may be refined topics which are not necessarily in original text.

In an embodiment of the invention, at least two of topics contained in a chat record may be extracted via semantic analysis. The invention has no limitation on the specific semantic analysis technology, and any suitable semantic analysis technology in the art may be used, such as existing syntax analyzer or potential semantic analysis method etc.

In an embodiment of the invention, it may further include performing manual adjustment to the extracted topic. User may select a part of historical chat record, and manually mark this part as a new topic. This may, on basis of automatic topic extraction, give user more flexibility and make user's usage more convenient.

In an embodiment of the invention, step 230 may include: determining that the second chat record is associated with at least one of the extracted topics; acquiring the second chat record. It can be seen that, step 230 may first determine association relationship of chat record and topic, and then acquire the chat record. For example, user may first determine that he or she wants to respond to some topic, then chat records to be created by the user are associated with that topic. Thus, it may be determined that the second chat record is associated with the corresponding topic before the second chat record is generated.

In an embodiment of the invention, step 230 may include: acquiring a third text-based chat record; determining that the third chat record is associated with at least one of the extracted topics, and using the third chat record as the second chat record. It can be seen that, step 230 may first acquire a chat record, and then decide whether that chat record is associated with at least one of the extracted topics, and the chat record is used as the second chat record if an association relationship is identified. No matter a user determines topics for chatting or performs topic matching via techniques such as semantic analysis, it can be realized that a chat record is first identified, and then it is decided whether the chat record is associated with a topic.

In the above embodiment, when determining whether a topic is associated with a chat record, it may be determined that the second chat record is associated with at least one of the extracted topics via user selection, that is, this association relationship is established based on user selection. Also, topics may be extracted for subsequent chat records, and the extracted topics from subsequent chat records are matched with previous existing topics, the subsequent chat records are associated with the previous topics if they match successfully, such that it is determined that the subsequent chat records are associated with at least one of the extracted topics. Alternatively, association between chat records and topics may be determined through semantic analysis technology. For example, whether a topic is associated with a chat record may be judged based on synonyms in a lexicon.

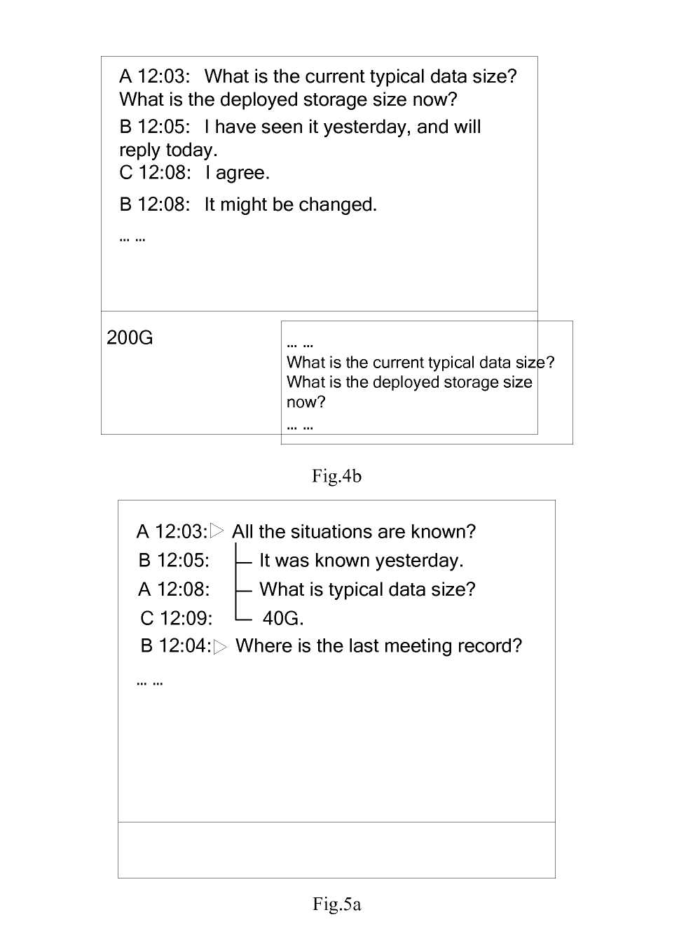

In an embodiment, step 230 may include: providing user B with at least one option, the at least one option corresponding to at least one of the extracted topics; associating, based on an option selected by user B, topic(s) corresponding to the selected option with the second chat record; and generating the second chat record, wherein, user B is the user generating the second chat record. Specifically, there are many ways for providing user B with options corresponding to the extracted topics. For example, as shown in FIG. 4a, in a history display portion of chat records, user may select one topic in the first chat record, and reply to the corresponding topic. Thus, by providing selectable topics in a history display portion, there is no need to additionally provide display space for options. In the embodiment shown in FIG. 4a, more selectable operations may also be displayed in user operable portion, such as, marking as a new topic etc. As shown in FIG. 4b, topics in the first chat record may be displayed to user in a separate display space, and user may select topics displayed in that separate display space. This can avoid the problem that, due to the history display portion of chat records being limited, part of the topics is no longer displayed in the current window, thus making user selection difficult or impossible. Further, in the embodiment shown in FIG. 4b, only topics in chat records of a certain speaker may be displayed; or topics in all chat records may be displayed. Alternatively, various topics may be ranked and displayed according to their priorities, for example, a topic that has not been replied is placed at top, or the most recent topic is placed at top, or topic of a VIP speaker is placed at top. Those skilled in the art can appreciate that, the above illustrative manners may be combined, and there are more manners capable of providing a user with topic related option(s). Furthermore, the displayed options may be a complete topic, a portion thereof, or information that is capable of representing the topic.

Those skilled in the art can appreciate that, the embodiment has no limitation on the order of performing steps of identifying the second chat record, providing user with option(s), or making an association. In this embodiment, once a user has selected an option, the association relationship between topics and chat records can be obtained. Establishment of the association relationship may be made by associating a chat record to be generated by a user with a topic corresponding to the selected option once the user has made the selection; or by associating a chat record with a topic corresponding to the selected option when or after the user generated the chat record.

Furthermore, the obtained association relationship may also be saved for the purpose of later displaying or further operations. For example, the association relationship may be saved in the form of a table or a tree. An example of saving the association relationship is explained below with reference to Table 1.

TABLE 1
Storage Of Chat Record

| Topic | Record | | | | | Associa- |
|---|---|---|---|---|---|---|
| ID | ID | Timestamp | Speaker | Content | Closed | tion |
| 256 | 160 | 2012/01/01 | Tom | Client | Y | 232 |
| | | 12:03 AM | | demand | | |
| | | | | will be | | |
| | | | | provided | | |
| | | | | to us | | |
| | | | | tomorrow. | | |
| 257 | 160 | 2012/01/01 | Tom | What is | Y | 0 |
| | | 12:03 AM | | the | | |
| | | | | maximum | | |
| | | | | storage | | |
| | | | | size | | |
| | | | | mentioned | | |
| | | | | last time | | |
| 258 | 160 | 2012/01/01 | Tom | Whether | N | 0 |
| | | 12:03 AM | | the mail | | |
| | | | | received | | |
| | | | | yesterday | | |
| | | | | is replied | | |
| . . . | . . . | . . . | . . . | . . . | . . . | . . . |
| 264 | 167 | 2012/01/01 | Jimmy | 200G | Y | 257 |
| | | 12:08 AM | | | | |
| . . . | . . . | . . . | . . . | . . . | . . . | . . . |

In this embodiment, each of the extracted topics may be assigned a topic ID, and a chat record may also be assigned a record ID. Those skilled in the art can appreciate that, if topic ID alone can uniquely identify a topic, then record ID may be ignored. A topic may be uniquely identified at least by combining topic ID and record ID together. A timestamp may record time of chatting; and a corresponding time may be retrieved according to the timestamp if later there is a need to display the records or topics in time series. A speaker may be recorded as the generator of a chat record, and the speaker of each chat record or each topic may be retrieved from Table 1 if later there is a need to differentiate the respective speakers or assign different priorities to different speakers. Since some topic is a question, a “Closed” column is provided in Table 1 to record whether the question has been answered. If the question has been answered or needs not to be answered, then Y is marked; if the question has not been answered, then N is marked. In order to record with which topic each chat record or topic is associated, an “Association” column is provided in Table 1. For example, the chat topic whose record ID is 167 is a reply to the topic whose topic ID is 257, i.e. is associated with the topic whose topic ID is 257, thus the topic ID 257 of that topic is recorded in the “Association” column. Those skilled in the art can appreciate that, more properties can further be recorded in Table 1 in order to subsequently realize more diversified operations, or properties recorded in Table 1 may be reduced, for example, only ID and Association column capable of uniquely identifying a topic are provided.

In an embodiment of the invention, step 240 may indicate that the first chat record and the second chat record are in an association relationship by marking the first chat record and the second chat record with the same color. In another embodiment, an association relationship between a first chat record and a second chat record may be indicated by employing the same font for both records. In another embodiment, an association relationship between a first chat record and a second chat record may be indicated by employing the same font size for the two. Those skilled in the art can appreciate that other manners may also be utilized to make the chat records look alike to represent association relationship among them, or a combination of various manners may be used.

In an embodiment of the invention, step 240 may include: displaying the first chat record and the associated second chat record when at least one of the two records is selected by a user. That is, in the case that a user has not made a selection, it is not displayed that the first chat record and the second chat record are associated; and the association relationship will not be displayed until a user has selected one. This can maximally prevent the display of historical chat records from being too complicated, and meanwhile, association of chat records may also be displayed according to user's demand, thus helping user understand the relationships among the chat records. Those skilled in the art can appreciate that, based on this example, many other displaying manners can also be obtained, such as providing a navigation column for all topics and when clicking on different topics, corresponding chat records in association relationship will be displayed according to chat records associated with the topic.

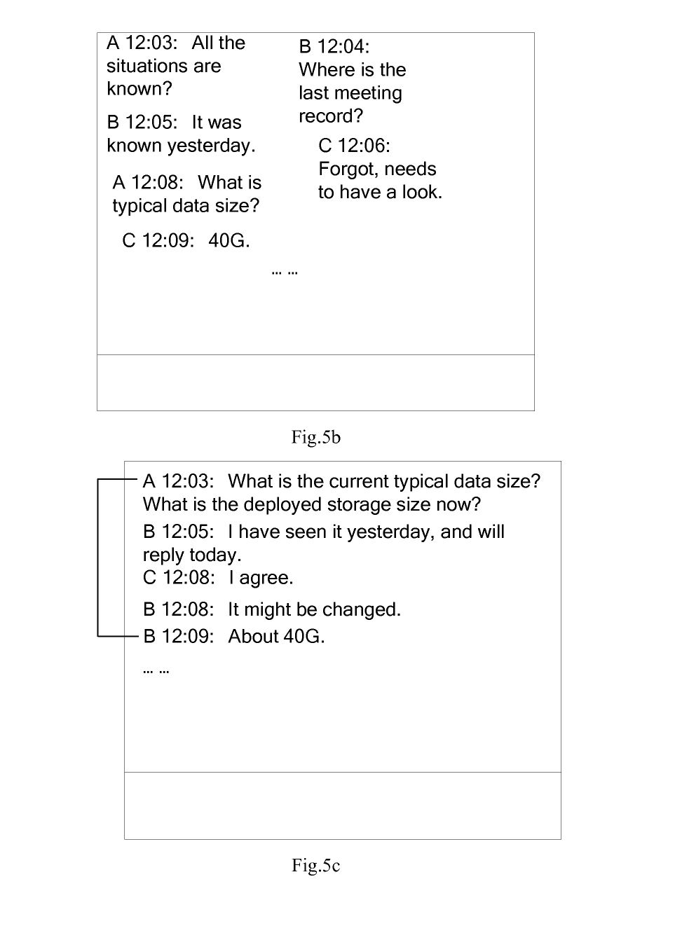

In an embodiment of the invention, step 240 may include: displaying the first chat record and the associated second chat record together, wherein displaying together may be achieved through the chain structure shown in FIG. 5a. Further, whether to unfold the chain structure may be chosen by user. Thus, space needed to display historical chat records will be smaller, that is, more historical chat records could be displayed within a display space of a particular size. Moreover, user can clearly see chat records that are associated with each other. Displaying together may also be achieved in a clustered manner, i.e., clustering the chat records in association relationships so as to be displayed together, which is illustrated in FIG. 5b.

In an embodiment of the invention, step 240 may further include: displaying a link between the first chat record and the associated second chat record. As shown in FIG. 5c, a link between the first chat record and the associated second chat record is displayed, and a user can learn that the chat records are associated with each other based on that link.

In an embodiment of the invention, step 240 may include, for example: displaying that a topic associated with the associated second chat record, i.e., at least one of the extracted topics and the second chat record are associated. In this embodiment, the association relationship between the second chat record and the topic is displayed in more details, not merely the association relationship between the two chat records. By displaying the association relationship between a chat record and a topic, with which the second chat record is associated with can be displayed more clearly when there are a plurality of topics (especially multiple questions) contained in one chat record. Association relationship of topics and chat records may be achieved by referring to the method of displaying that two chat records are associated in the above embodiments.

In an embodiment of the invention, semantic analysis may also be performed on the second chat record, and at least two topics contained in the second chat record are extracted. Step 240 may include: displaying that the topic in the first chat record and the topic in the corresponding second chat record are in an association relationship. By displaying the association relationship of topic time contained in different chat records, which topic is associated can be displayed more clearly when each of the multiple chat records contains a plurality of topics.

In an embodiment of the invention, it can further include: evaluating an importance value of the chat records; displaying the records according to the importance value. In this embodiment, evaluating importance value is performed automatically, for example, according to a predetermined rule. The predetermined rule may include, for example, at least one of the following: chat records containing a question which has not been answered are more important than chat records containing a question which has been answered; chat records generated by a particular person are more important than chat records generated by other persons; chat records containing certain keywords are more important than other chat records; chat records with later generation time are more important than chat records with earlier generation time; chat records with larger number of reply records are more important than chat records with less reply records. In this embodiment, displaying chat records according to an importance value may comprise at least one of the following: displaying more important chat records with larger font; displaying more important chat records with bolder font; placing more important chat records at locations where it can be found more easily in historical chat records; displaying more important chat records in color that could be noticed more easily. Those skilled in the art can appreciate that, based on the above examples, there may be more predetermined rules or displaying manners, wherein the displaying method enables user to find more important chat records more easily. Those skilled in the art can appreciate that, the displaying method provided by this embodiment may be combined with display of association relationships mentioned in the above embodiments, i.e., importance value of different chat records are represented while displaying association state. Based on different methods for evaluating importance degree and different displaying methods, importance degree can be distinguished among all chat records associated under a same topic, or chat records may be displayed across topics according to importance degree.

In an embodiment of the invention, the acquired second chat record may be taken as the first chat record, which is processed according to the method provided by the above embodiments, thereby acquiring a plurality of chat records associated with the same topic. In another embodiment of the invention, a plurality of chat records associated with the same topic may be acquired by obtaining a plurality of second chat records associated with a topic extracted from the first chat record.

With the above embodiments of the invention, mining of potential relationships among scattered chat records may be realized by automatic identification of topics contained in the chat records, and such potential relationships are presented to a user, or such potential relationships are presented by reorganizing the historical chat records, so that a user can obtain chat records under the same topic clearly and conveniently, thereby improving efficiency of text-based information communication and facilitating sorting afterwards. The above embodiments of the invention are applicable to instant communication tool, forum, online meeting tool, electronic bulletin board system and mail system etc., and may bring convenience to people's information exchange.

More examples can be obtained by referring to and combining the above various embodiments of the invention with each other. For example, the above various examples of displaying association state can be combined with each other to obtain more examples of displaying association state.

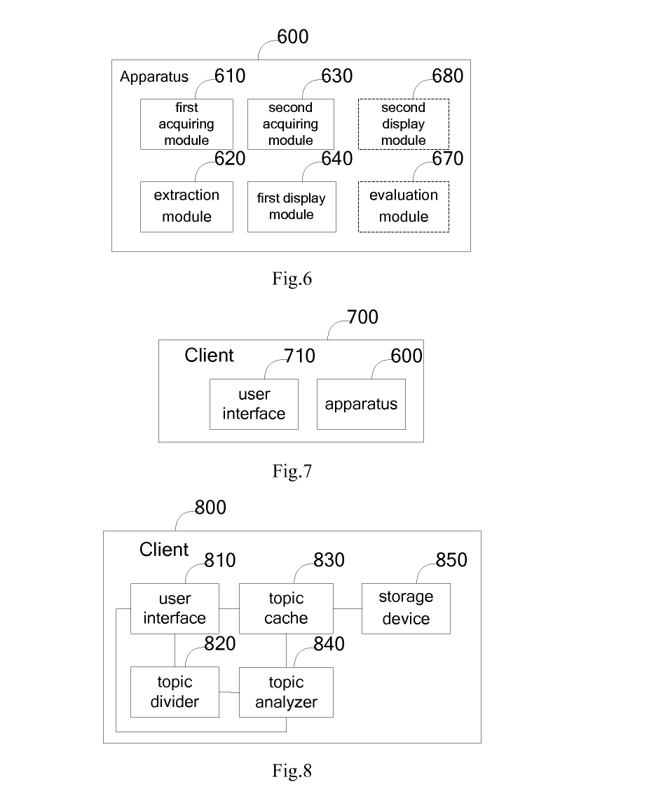

As shown in FIG. 6, an embodiment of the invention provides an information processing apparatus 600. The apparatus 600 includes: a first acquiring module 610 configured to acquire a first text-based chat record; an extraction module 620 configured to extract at least two of topics contained in the first chat record; a second acquiring module 630 configured to acquire a second text-based chat record, the second chat record being associated with at least one of the extracted topics; a first display module 640 configured to display that the first chat record and the second chat record are in an association relationship.

With the apparatus provided in this embodiment, it is achieved that, topics are extracted for chat records containing a plurality of topics, thereby associating chat records with the extracted topics, thus, chat records with related topics may be associated and displayed together, so as to help the participants understand the relationships and logic among chat records, improve efficiency of text-based communication and also facilitate sorting the chat records afterwards.

In an embodiment of the invention, the extraction module 620 may include: a detection sub-module configured to detect keyword(s) contained in the first chat record, the keyword(s) including at least one of keywords for representing a transition, keywords for representing asking a question and keywords for representing sequence; a division sub-module configured to divide the first chat record into a plurality of topics according to the detected keyword(s), at least two of the plurality of topics resulted from the division are used as at least two of topics contained in the first chat record.

In an embodiment of the invention, the extraction module 620 may be configured to: extract at least two of topics contained in the first chat record by performing semantic analysis on the first chat record.

In an embodiment of the invention, the second acquiring module 630 includes: a first decision sub-module configured to determine that the second chat record is associated with at least one of the extracted topics; a first acquiring sub-module configured to acquire the second chat record.

In an embodiment of the invention, the second acquiring module 630 includes: a second acquiring sub-module configured to acquire a text-based third chat record; a second decision sub-module configured to determine that the third chat record is associated with at least one of the extracted topics, and use the third chat record as the second chat record.

In an embodiment of the invention, the second acquiring module 630 includes: an option sub-module configured to provide user C with at least one option, the at least one option corresponding to at least one of the extracted topics; an association sub-module configured to associate, based on an option selected by the user C, topic(s) corresponding to the selected option with the second chat record; a third acquiring sub-module configured to acquire the second chat record.

In an embodiment of the invention, the first display module 640 is configured to: display that the at least one topic and the second chat record are in an association relationship. That is, the first display module 640 is configured to: display that topic associated with the second chat record in the extracted topics and the second chat record are in an association state.

In an embodiment of the invention, the apparatus 600 further includes: an evaluation module 670 configured to evaluate the importance of the chat records; a second display module 680 configured to display the chat records according to the importance value.

For detailed implementation in the above apparatus embodiments, reference may be made to the method embodiments. Those skilled in the art can appreciate that, more embodiments can be obtained by referring to and combining the above various apparatus embodiments with each other.

As shown in FIG. 7, an embodiment of the invention provides a client 700, which comprises a user interface 710 and the apparatus 600 as shown in FIG. 6. Wherein both first display module 640 and/or second display module 680 in apparatus 600 display chat records via the user interface 710. Further, the apparatus 600 receives chat records inputted by users via the user interface 710.

As shown in FIG. 8, the embodiment of the invention provides a client 800, which comprises a user interface 810, a topic divider 820, a topic cache 830, and a topic analyzer 840, wherein the user interface 810 is configured to receive chat records inputted by user, and display chat records and association relationship between chat records and topics to the user; the topic divider 820 is configured to divide the received chat record into one or more topics; the topic analyzer 840 is configured to analyze association relationship between the divided topics and other chat records; the topic cache 830 caches the received chat records and the obtained association relationship. In an embodiment of the invention, it further comprises a storage device 850, which stores content of the topic cache 830 at local. The topic analyzer 840 may be further configured to evaluate and rank importance degree of chat records, and perform different presentation on chat records with different importance degree in the user interface 810.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An information processing method, comprising:
acquiring a first text-based chat record;
extracting at least two topics contained in the first chat record;
acquiring a second text-based chat record, the second chat record being associated with at least one of the extracted topics; and
displaying that the first chat record and the second chat record are in an association relationship.

2. The method according to claim 1, wherein the step of extracting at least two of topics contained in the first chat record comprises:
detecting keyword(s) contained in the first chat record, the keyword(s) including at least one of keyword for representing a transition, keyword for representing asking a question and keyword for representing sequence; and
dividing the first chat record into a plurality of topics according to the detected keyword(s), wherein at least two of the plurality of topics resulting from the division of the first chat record are used as at least two of topics contained in the first chat record.

3. The method according to claim 1, wherein the step of extracting at least two topics contained in the first chat record comprises extracting the at least two topics contained in the first chat record by performing semantic analysis on the first chat record.

4. The method according to claim 1, wherein the step of acquiring a text-based second chat record, the second chat record being associated with at least one of the extracted topics comprises:
determining that the second chat record is associated with at least one of the extracted topics; and
acquiring the second chat record.

5. The method according to claim 1, wherein the step of acquiring a text-based second chat record, the second chat record being associated with at least one of the extracted topics comprises:
acquiring a text-based third chat record; and
determining that the third chat record is associated with at least one of the extracted topics, and using the third chat record as the second chat record.

6. The method according to claim 1, wherein the step of acquiring a text-based second chat record, the second chat record being associated with at least one of the extracted topics comprises:
providing a first user with at least one option, the at least one option corresponding to at least one of the extracted topics, the second chat record being issued by the first user;
associating, based on an option selected by the first user, topic(s) corresponding to the selected option with the second chat record; and
acquiring the second chat record.

7. The method according to claim 1, wherein the step of displaying that the first chat record and the second chat record are in an association relationship comprises:
displaying that the at least one topic and the second chat record are in an association relationship.

8. The method according to claim 1, wherein the method further comprises:
evaluating an importance degree of the first chat record and the second chat record; and
displaying the first chat record and the second chat record according to the importance degree.

9. An information processing apparatus, comprising:
a first acquiring module configured to acquire a first text-based chat record;
an extraction module configured to extract at least two topics contained in the first chat record;
a second acquiring module configured to acquire a second text-based chat record, the second chat record being associated with at least one of the extracted topics; and
a first display module configured to display that the first chat record and the second chat record are in an association relationship.

10. The apparatus according to claim 9, wherein the extraction module comprises:
a detection sub-module configured to detect keyword(s) contained in the first chat record, the keyword(s) including at least one of a keyword for representing a transition, a keyword for representing asking a question, and a keyword for representing sequence; and
a division sub-module configured to divide the first chat record into a plurality of topics according to the detected keyword(s), wherein at least two of the plurality of topics resulting from the division are used as at least two of topics contained in the first chat record.

11. The apparatus according to claim 9, wherein the extraction module is configured to:
extract at least two of topics contained in the first chat record by performing semantic analysis on the first chat record.

12. The apparatus according to claim 9, wherein the second acquiring module comprises:
a first decision sub-module configured to determine that the second chat record is associated with at least one of the extracted topics; and
a first acquiring sub-module configured to acquire the second chat record.

13. The apparatus according to claim 9, wherein the second acquiring module comprises:
a second acquiring sub-module configured to acquire a text-based third chat record; and
a second decision sub-module configured to determine that the third chat record is associated with at least one of the extracted topics, and use the third chat record as the second chat record.

14. The apparatus according to claim 9, wherein the second acquiring module comprises:
an option sub-module configured to provide a first user with at least one option, the at least one option corresponding to at least one of the extracted topics, the second chat record being issued by the first user;
an association sub-module configured to associate, based on an option selected by the first user, topic(s) corresponding to the selected option with the second chat record; and
a third acquiring sub-module configured to acquire the second chat record.

15. The apparatus according to claim 9, wherein the first display module is configured to:
display that the at least one topic and the second chat record are in an association relationship.

16. The apparatus according to claim 9, wherein the apparatus further comprises:
an evaluation module configured to evaluate importance values of the first chat record and the second chat record;
a second display module configured to display the first chat record and the second chat record according to the importance values.

17. A non-transitory computer readable article of manufacture tangibly embodying computer readable instructions which, when executed, cause a computer to carry out a method comprising the steps of:
acquiring a first text-based chat record;
extracting at least two topics contained in the first chat record;
acquiring a second text-based chat record, the second chat record being associated with at least one of the extracted topics; and
displaying that the first chat record and the second chat record are in an association relationship.
